(19) United States
(12) Patent Application Publication
(10) Pub. No.: US 2012/0172017 A1
(43) Pub. Date: Jul. 5, 2012

(54) SYSTEM FOR DETERMINING CO2 EMISSIONS

(75) Inventors: Carlo Filippo Ratti, Cambridge, MA (US); Kristian Kloeckl, Somerville, MA (US); Vincenzo Manzoni, Bergamo (IT); Andrea Corti, Drezzo (IT)

(73) Assignee: Massachusetts Institute of Technology, Cambridge, MA (US)

(21) Appl. No.: 13/343,063

(22) Filed: Jan. 4, 2012

Related U.S. Application Data
(60) Provisional application No. 61/429,928, filed on Jan. 5, 2011.
(60) Provisional application No. 61/429,820, filed on Jan. 5, 2011.

(51) Int. Cl. H04W 4/02

(52) U.S. Cl. 455/414.1

(57) ABSTRACT

CO2G0 is a novel method to automatically estimate in real-time a person's CO₂ emissions associated with transportation mode choices using data—specific inertial information gathered from mobile phone sensors. CO2G0 automatically classifies the user's transportation mode among eight classes by using a Functional Tree. The algorithm is trained on features gathered from an accelerometer, GPS receiver and digital maps. A working smartphone application for the Android platform has been developed and experimental data have been used to train and validate the proposed method. A second algorithm computes the traveled distance, through an optimized mix of GPS and Internet map services.

This application claims priority to provisional application Ser. No. 61/429,820 filed on Jan. 5, 2011 and to provisional application Ser. No. 61/429,928 filed on Jan. 5, 2011, the contents of both of which are incorporated herein by reference.

### BACKGROUND OF THE INVENTION

This invention relates to the field of smart transportation, specifically through the development of an interactive smartphone application capable of estimating real-time transport mode and CO₂ emissions based on mode of transport.

The commoditization of sensors in mobile phones has increased their availability and provided researchers with opportunities to study large populations in a very low cost manner. One area of interest which can take advantage of the pervasiveness of these sensors is ‘activity inference’, i.e., the ability to tell what activity a person is performing based upon sensor information. ‘Activity inference’ has been applied in different areas, such as health monitoring, recommendation systems and study of personal behavior. Our attention here is focused on the transportation mode inference, to support the real time estimation of the carbon footprint of a traveler, using information from mobile phone sensors.

Each day, hundreds of people move around cities without realizing the effect of their transportation mode on the environment. According to Industrial Energy Analysis, transportation accounts for one quarter of the world's greenhouse gas emissions [1], with personal mobility consuming about two thirds of the total transportation energy use [2]. As carbon dioxide is considered one of the most important green house gases (GHG), environmental scientists have interest in making the public more aware of their impact on CO₂ emissions in order to aid its reduction. As a direct result, a myriad of web sites and mobile phone applications have been created to calculate the individual carbon footprint, i.e., the personal carbon emission.

These carbon footprint calculators fall into three broad groups based on the type of data input required: aggregated data, individual diary, and trip-by-trip data. All current web applications require manual data input—such as the number of miles traveled per year, vehicle type and size, etc., whereas some mobile phone applications use different levels of automatic recognition. The main drawback of these latter applications is that they use only the GPS velocity and heading to detect and identify the transportation mode. This can potentially cause two problems: This approach does not work in places where the GPS is weak due to the canyoning effect or is entirely absent [6]. Moreover, these systems do not exploit the latitude/longitude information: the user location can be snapped into digital maps to get a robust evaluation of the transportation mode (e.g., a vehicle moving on a railway will likely be a train). On the other hand, the accelerometer data is preferable for its availability but its measurements are deeply influenced by how the phone is being held. For example, if the user does not move but shakes the phone, the accelerometer gauges fake accelerations and the classification becomes inaccurate. Our system aims to combine the complementary sensors' behavior to guarantee transportation mode accuracy and availability.

The system disclosed herein is the first integrated smartphone system that is able to leverage built-in sensors to detect in real time, mode of transportation and CO₂ emissions, and present them to the user in order for them to view their individual CO₂ emissions from a journey. Furthermore it also provides the user with a means of comparison, allowing users to share their travel routes and emissions with other users. Consequently they are able to identify whether they contribute to an increase or decrease in average CO₂ emissions. This information enables users to make more informed decisions as to their choice of transport and route of their journey, in order to reduce CO₂ emissions generated.

### SUMMARY OF THE INVENTION

The system of the invention for automatically estimating in real time a person's carbon dioxide emissions includes a mobile device including an accelerometer, a GPS receiver and a data plan connection for computing distance travelled. The mobile device, such as a smartphone, is programmed to pre-process signals from the accelerometer to address variable inter-sample intervals. It is also programmed to apply a supervised machine learning algorithm based on functional trees to features computed by Fast Fourier Transform of total acceleration acting on the mobile device and computed from the pre-processed signals to determine the mode of transportation of the mobile device. Carbon dioxide emissions are computed from the mode of transportation and distance travelled.

CO2GO, as the system disclosed herein is known, proposes a novel method to identify the transportation mode in real-time using inertial information gathered from mobile phone sensors. The algorithm, based on a Functional Tree algorithm, provides a real-time, fine grained identification of the transportation mode among eight classes: bus, subway, walk, bike, train, car, motorcycle and still. The system also leverages the result of the identification for estimating the emissions of CO₂ in real time. Finally, an application implementing the classification algorithm for mobile phone based on Android operating systems has been developed and tested.

While there has been some research in this field, most efforts have focused on the deployment of ad hoc sensors carried by people to identify the transportation mode, hence limiting the size of deployment and accessibility. In contrast, CO2GO uses standard smartphones and a custom developed algorithm using data from an accelerometer, GPS and online map readings. Furthermore, the algorithm is structured in a way that allows the cell phone to be randomly positioned in a user's pocket. The device does not require specific positioning or orientation.

Our approach for the first time enables an unlimited number of people to run this application all day long on standard smartphones. We make use of an existing infrastructure (smartphones) that are already available in large numbers, Potentially, this could allow very large numbers of people to adopt it, providing them with information on their mobility patterns. Also, this will allow an unprecedented collection of data on mobility when shared with researchers,

In order to restrict the battery consumption by the applications, CO2GO implements a battery saving strategy that automatically switches to an idle state, turning off the accelerometer, GPS and data connection, when no movement is detected.

Finally, the data is made relevant to the user by converting it into CO₂ emissions (as a function of mode of transportation and distance) and burnt calories (health monitoring). This information is provided through the user interface, which is updated in real-time alongside a map tracing the user's route. The user is able to view their own CO₂ emissions from a journey, as well as other user's total and average emission values through the “city” view. The information provides the user with an insight into whether they contribute to an increase or decrease in average CO₂ emissions. Furthermore this application provides information, which allows the user to make more informed decisions as to their journeys. For example, one might choose an alternative route that is used by another user and depicted on the “city” view, based on its lower emissions. CO2GO allows users to tap into the collective effort to reduce CO₂ emissions created by urban mobility.

### BRIEF DESCRIPTION OF THE DRAWING

FIG. 1 is a view of the user interface used with an embodiment of the invention disclosed herein.

FIG. 2 is a graph showing a Bode diagram for the digital low-pass filter used in an embodiment of the invention.

FIG. 3 is a block diagram for the acceleration signal pre-processing algorithm used in an embodiment of the invention.

FIG. 4 is a schematic illustration showing the reference system used herein.

FIG. 5 is a series of spectrograms of different transportation modes.

FIG. 6 is a series of spectrograms having different window sizes and window overlaps for a same walking trace.

FIG. 7 is a series of spectrograms with a different number of coefficients for a same walking trace.

FIG. 8 is a GPS trace collected by the phone app and railways rail provided by OSM map.

FIG. 9 is a graph comparing distances computed using GPS and Google Maps.

FIG. 10 is a schematic diagram of a battery savings strategy.

### DESCRIPTION OF THE PREFERRED EMBODIMENT

A description of the CO2O application is provided here, with each element of its development examined in detail. The first section describes the algorithm for the automatic identification of the transportation mode, which consists of two further sub-sections. First, the signals acquired from the accelerometers and GPS are pre-processed and combined with digital maps to extract the characteristic features. Then, a supervised machine learning algorithm based on the Functional Trees is applied to the features computed. The second section provides information as to the distance computation and battery savings strategy.

The CO2GO application may be implemented on any mobile phone provided it has an accelerometer and a GPS receiver. The digital map can be integrated inside the application or can be queried using web services (in our implementation we used OpenStreetMapx-API). For the algorithm design and testing, a development phone was chosen: a Google Nexus One with the Google Android 2.2 operating system. Primarily this phone was employed, as it is programmable with a fully-fledged programming language based on Java syntax, inside an integrated development environment. The accelerometer integrated in the Google Nexus One is a BMA150. It measures the accelerations within a range of ±2 g (±19.61 m/s² ) with a sensitivity of 4 mg (0.039 m/s²). The OpenStreetMap maps are chosen because they provide information about the railway, subway and bike-lane.

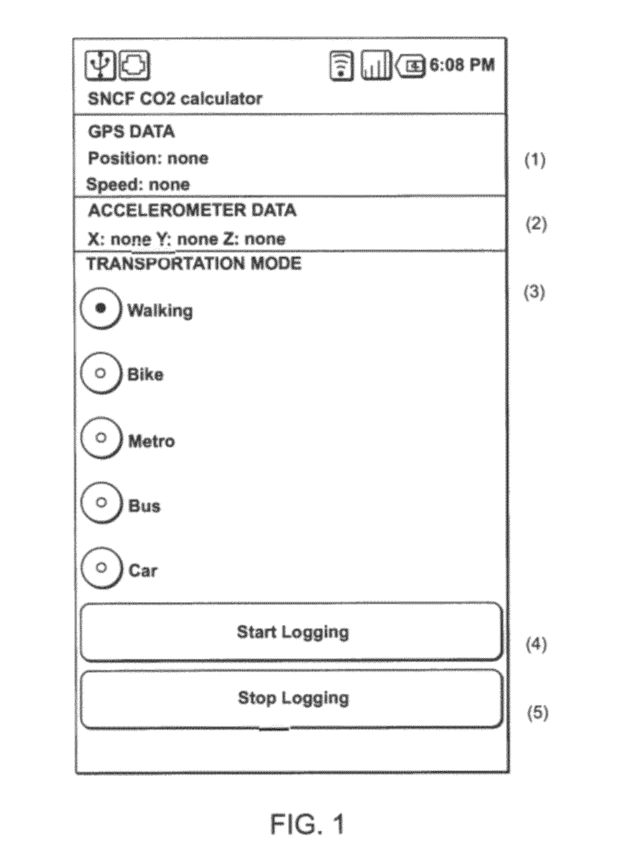

The traces collection and labeling according to different transportation modality is 130 performed through a custom application developed for such purpose. FIG. 1 shows its user interface. Parts (1) and (2) show the real-time data for debugging purposes. Part (3) allows the user to select the transportation modality. Parts (4) and (5) starts and stops the logging process. The x, y and z acceleration, together with GPS data for validation, are collected as fast as the mobile phone allows.

Google Nexus One samples the accelerations with an average sampling rate of 25 Hz and the GPS data (absolute position according to WGS-84 datum, accuracy and speed) with a frequency of 1 Hz. Unfortunately, the operating system did not guarantee a fixed sampling frequency which varies according to the user activity. For this reason, data pre-processing is required.

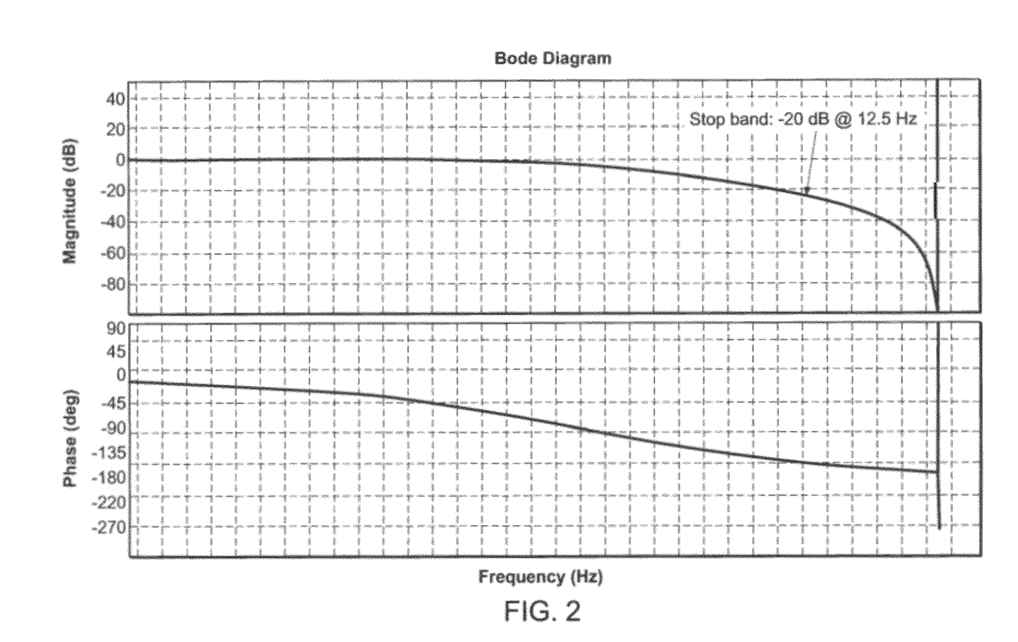

Signal Pre-Processing: The transportation mode classification algorithm is based on features computed on the FFT coefficients of the total acceleration and it relies on samples acquired with a fixed sampling time. Moreover, different mobile phones have different average sampling frequencies, due to computation power or active services. Therefore, the FFT cannot be performed directly, but a signal pre-processing phase is used. Piecewise linear interpolation is employed as it is faster to compute and easier to implement on the mobile phone. Moreover, the high-frequencies introduced by the piecewise linear interpolation can be removed by a low-pass filter. The signal is therefore interpolated, re-sampled with a constant sampling frequency of 50 Hz and then filtered with a digital, second-order, low-pass filter with a cut-off frequency of 5 Hz. The average slower sampling frequency among the mobile phone that we were able to try was 25 Hz. Therefore, the filter has been designed to have an attenuation of −20 dB in stop band at 12.5 Hz according to the Nyquist theorem (see FIG. 2).

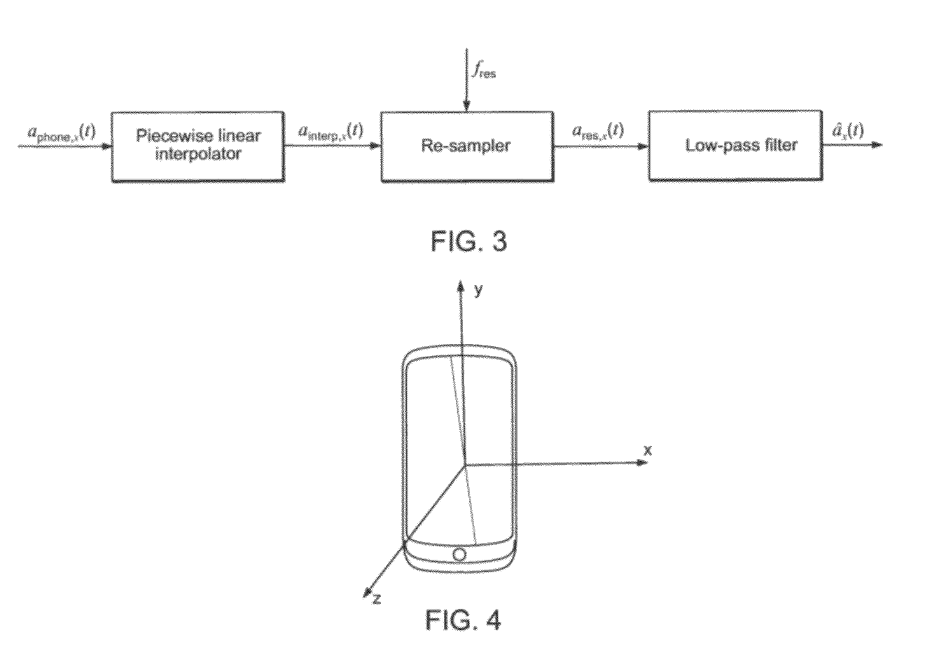

Moreover, the filter order is chosen as a compromise between the attenuation rate and the implementation complexity. FIG. 3 shows the block diagram of the pre-processing algorithm, where a_{phone,x}(t) is the acceleration along the x axis read from the phone, a_{interp,x}(t) is the acceleration after the linear piecewise interpolation, fᵣₑₛ is the re-sampling frequency, a_{res,x}(t) is the acceleration signal re-sampled and, finally, âₓ(t) is our estimation. For sake of simplicity, only the x axis is shown, but the algorithm is applied to all three axes.

Feature computation: Acceleration features are computed from an orientation invariant signal, rather than using a fixed, known or estimated orientation. Such signal is the total acceleration, âₜₒₜ(t) computed as follows:

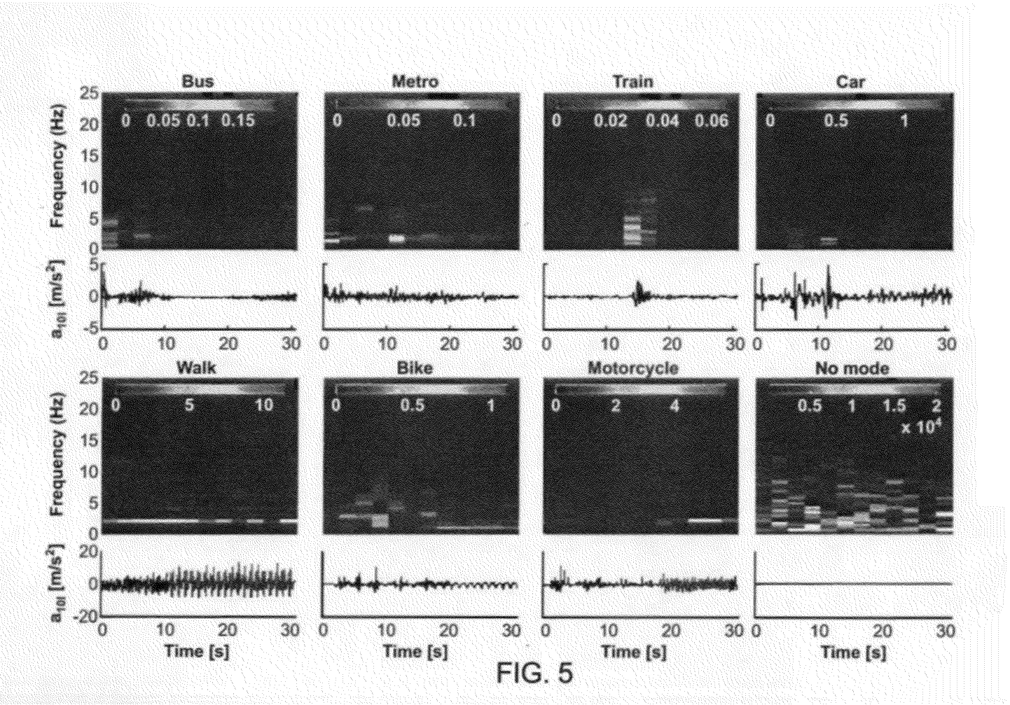

\hat{a}ₜₒₜ(t)=\sqrt{\hat{a}ₓ(t)²+â_{y}(t)²+â_{z}(t)²}, (1)

where âₓ(t), â_{y}(t) and â_{z}(ₜ) are the accelerations according to the reference system shown in FIG. 4, processed with the algorithm shown in FIG. 3.

Other orientation invariant signals can be computed, such as the sum of the absolute value of the acceleration. However, the total acceleration has been chosen for its clear physical meaning.

The signal âₜₒₜ(t) differs from one transportation mode to another. FIG. 5 shows traces of 8 transportation modes in the domain of time and frequency. The spectrogram is computed by applying the FFT on a window 128-seconds long, with no overlap between two consecutive windows. The differences are particularly evident in the time-varying spectral representation. As previous works state, the FFT coefficients can be successfully used as features for a classification algorithm.

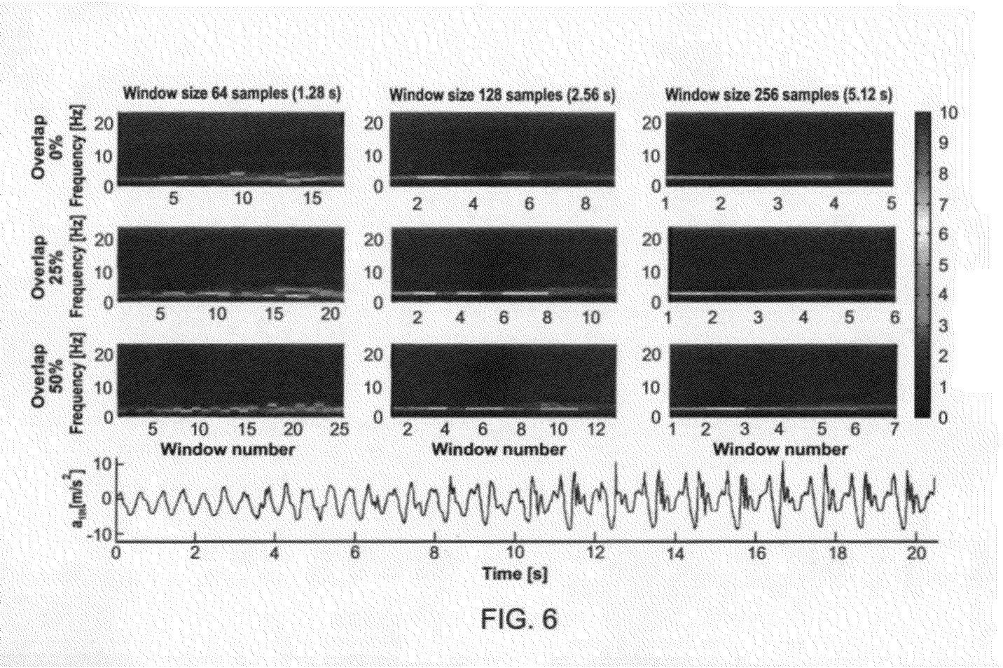

The windows size and overlap—i.e., the percentage of overlapping of two consecutive windows—affect the temporal resolution of the spectrogram and therefore the classification accuracy. FIG. 6 shows a comparison among spectrograms computed using different window sizes (64, 128 and 256 samples) and windows overlaps (0, 25 and 50%) for a same trace. For our purposes, on one hand small windows and high overlaps generate more instances to train and validate the algorithm and they quickly detect the change. On the other hand, small windows could not catch the distinctive behavior of the transportation system. Finally, high overlaps can overfit the classification algorithm.

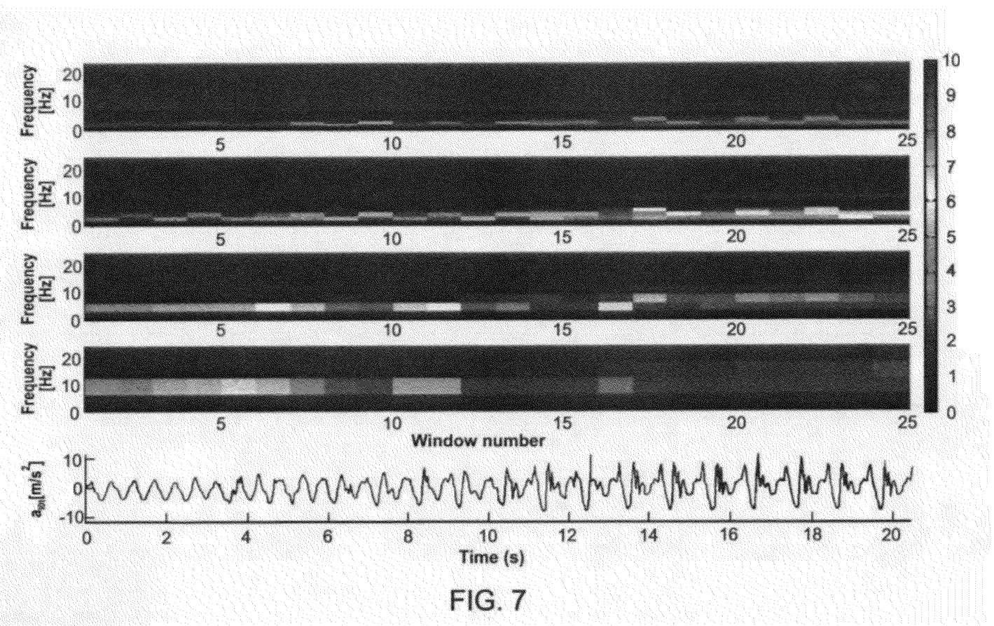

The frequency resolution is also important for the classification algorithm. FIG. 7 shows a comparison among four spectrograms computed on the same trace (shown on the bottom) with a different number of FFT coefficients (32, 16, 8 and 4). Even in this case, a smaller frequency resolution can determine different transportation modes. On the other hand, the algorithm can be more general.

The accuracy of the classification strongly depends on these three parameters: window size, window overlap and number of FFT coefficients. The value of the parameter which maximizes the classification accuracy is computed through an optimization carried out in two steps.

The GPS signal provided by the phone every 1 Hz measures the velocity, orientation with respect to north pole, latitude, and longitude of the receiver. The features used by the machine-learning algorithm are computed by analyzing this information inside the time window.

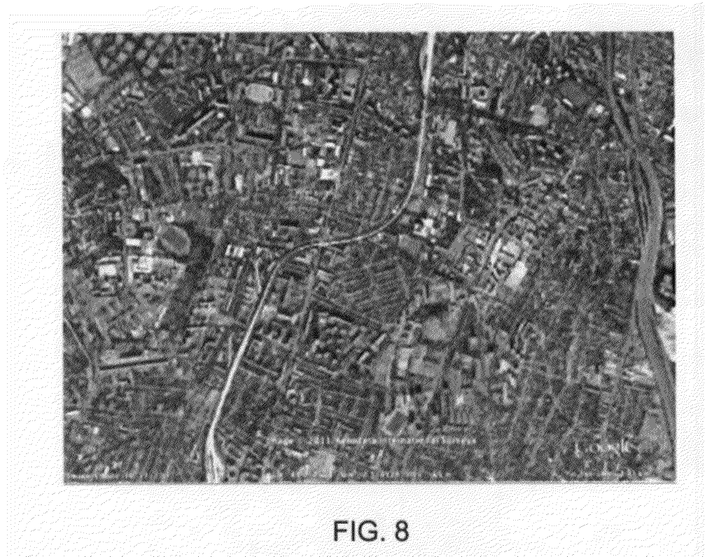

Moreover, the latitude and the longitude are combined with digital maps to strengthen the approach accuracy. In FIG. 8 is presented an example of a GPS trace collected in the city of Paris, France.

The phone periodically queries a digital map to extract all the railway, subway and bike-lanes near the GPS points. For each GPS point (x_{GPS}, y_{GPS}) the algorithm computes the geometrical distance (2) d from all the over ground segments. The minimum distance is computed for each category (railway, subway, bike-lane) and then used as an additional feature.

$$d ( {x}_{GPS} , {y}_{GPS} ) = \frac{\vert {y}_{GPS} - {mx}_{GPS} - q \vert}{\sqrt{1 + {m}^{2}}} , \qquad ( 2 )$$

### Transportation Mode Classification: Functional Tree Algorithm.

For our CO2GO application, supervised algorithms are used, primarily as we have a training set which is labeled with the actual transportation mode. Different supervised-learning techniques can be used as classifier. We compared different algorithms available and the Functional Tree algorithm has been shown to perform better then all the others. Furthermore, they can correlate the FFT coefficients value with the transportation mode. In this way, the signal processing can be iteratively optimized for further improving the classification accuracy.

The functional tree algorithm has been trained using Weka [17], a well-known environment for knowledge analysis. The tree has been generated using the algorithm proposed in [12] and validated using the k-fold cross validation [13], where k is equal to 10. The k-fold cross validation is preferred because it performs better for small size sets.

It is worth noting that each instance represents a 5-seconds window of the signal.

The feature set is therefore composed of:
32 FFT coefficients, computed on a window 512 samples long (10.24 seconds), with a windows overlap of 50% (5.12 seconds),
The signal variance, computed as the sum of the FFT coefficients.
The average and the standard deviation of GPS speed.
The percentage of samples below 4 km/h, between 4-40 km/h, over 16 km/h.
The maximum change of orientation.
The average of the minimum distance between the GPS locations and the railways, subways and bike-lanes.

Distance computation: The CO₂ emissions are computed as the sum of the product between the distance traveled with a transportation mode and a coefficient, estimated by environmental agencies (Coefficients are summarized in Table 1). The model used in the computation can be formalized as follows.

TABLE 1
CO₂ emission per transportation mode
(source: French Environmental Agency).

| Transportation mode | CO₂ Emission value | |
|---|---|---|
| Subway | 3.3 | g/(traveller · km) |
| Bus | 100 | g/(traveller · km) |
| Train | 43 | g/(traveller · km) |
| Car (extra-urban roads) | 85 | g/(traveller · km) |
| Car (urban roads) | 149 | g/(traveller · km) |
| Motorcycle | 125 | g/(traveller · km) |
| Walking | 180 | g/(traveller · km) |
| Bike | 75 | g/(traveller · km) |

All the coefficients, except the ones for walking and biking, have been provided by the French Environmental Agency.

Previous work has computed the distance traveled exploiting the Global Positioning System GPS). All modern smartphones contain a GPS receiver, however the estimation accuracy of their position is low. Although, considering the approximation on the computation of the CO₂ coefficients, it can be considered sufficient for our purpose. Nonetheless, the GPS technology has a main drawback: It does not perform in an in-doors environment. This raises the issue of how to compute the distance in a building, underground or inside tunnels.

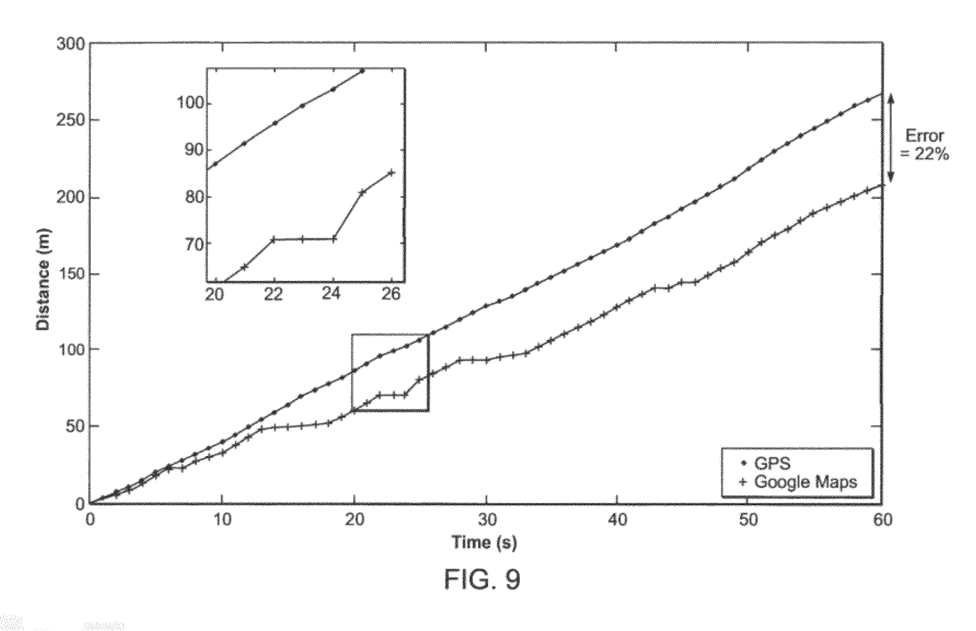

As an example, FIG. 9 compares the distance computed applying the Heaviside distance on the latitude and longitude obtained from the GPS receiver (bold line) and the distance computed querying Google Maps with all the waypoints (solid line). The detail of the comparison reveals that the distance computed as a sum of GPS distance is increasing, even if the distance computed using Google Maps is not. In fact, in those points the vehicle was still at the traffic light. The oscillation is due to the low accuracy of the GPS, which causes a jumping back and forth of the estimation. Google Maps understands the error and compensates it with its road snapping algorithm.

l The Internet provides several web services for computing the distance or the route between a source and a destination. Most of them provide a basic function for free, and then upgrade service after the payment of a fee. For example, Google Maps allows only 2,500 queries per day at its direction web service. This limitation limits the number of computations allowed. However, every query can contain one source, one destination and up to 8 waypoints, which means 9 legs. This pushes the limitation up to 22,500 points.

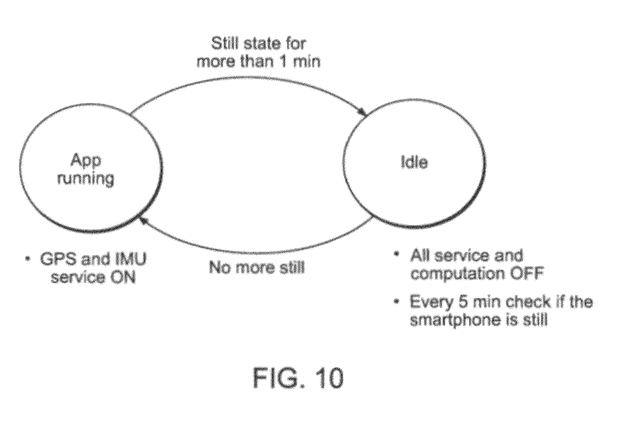

Energy efficiency: A key factor in every smartphone application that extensively uses sensors is its power consumption. Previous works [5],[9],[11] have shown the impact of the GPS receiver on the battery duration. We have estimated in 10 continuous hours the time needed by the application to completely discharge the phone battery (1400 mAh). It is worth noticing that CO2GO is usually not running continuously. A battery saving strategy (depicted in FIG. 10) is implemented to reduce the power consumption. The GPS and accelerometer sensors are activated only when movement is detected; otherwise the application automatically switches to idle state and reduces its power consumption.

The classification algorithms have been trained and validated using real-world data, gathered using a custom mobile application able to label data with the transportation mode. The generated functional tree has 110 leaves and a size of 219, with the confusion matrix associated with the classification algorithm in Table 2.

TABLE 2
Classification accuracy represented as a confusion matrix.

| classified as | | | | | | | |
|---|---|---|---|---|---|---|---|
| a | b | c | d | e | f | g | |
| 300 | 17 | 0 | 4 | 33 | 0 | 53 | a = 1 |
| 17 | 347 | 0 | 6 | 17 | 20 | 0 | b = 2 |
| 0 | 0 | 406 | 0 | 1 | 0 | 0 | c = 3 |
| 3 | 6 | 1 | 388 | 2 | 7 | 0 | d = 4 |
| 45 | 16 | 0 | 2 | 341 | 3 | 0 | e = 5 |
| 1 | 23 | 0 | 5 | 3 | 375 | 0 | f = 6 |
| 4 | 0 | 0 | 0 | 0 | 0 | 403 | g = 7 |

The experimental results show an accuracy identification of around 90%, with walking correctly classified 406 times out of 407. The confusion matrix further allows us to identify the transportation modes which require improvements to their classification.

The CO₂GO application presents information through a user interface, with the mode of transport shown to ensure the correct functioning. Travel time, distance covered and associated CO₂ emissions are depicted in real time, along with a map of the user's route. The “city” view provides insight into how the user's carbon emissions and travel distance compare to their fellow user's total and average values. This enables the user, among others, to identify whether they are contributing to an increase or decrease in average CO₂ emissions. Within the “share” screen a user can give others access to select travel routes and their emissions as well as being able to consult other user's low emission routes-tapping into a collective effort to reduce CO₂ emissions generated by urban mobility. Finally, the present invention informs users about calories burned during their individual journey, offering an insight into health issues while on the move.

CO2GO as described here is thus a software engine responsible for the collection and interpretation of data generated by a smartphone's sensors. Accelerometer and GPS traces are interpreted by the algorithm which allows eight different transportation modes to be identified: bus, subway, walk, bike, train, car, motorcycle and still. Furthermore the GPS data alongside online map queries construct the route of the user's journey, which may be viewed by the user. The system leverages the results of the identification for estimating the emissions of CO₂ in real time, thus providing the users with an insight into their personal carbon footprint, alongside additional information such as the total calories burned during their journey. The CO2GO application also provides a “city” view, which allows the user to view other user's total and average CO₂ emissions values. It consequently provides the individual with a tool to identify whether they are contributing to an increase or a decrease in average CO₂ emissions. Furthermore the “share” screen permits users to share travel routes and emissions. Finally the invention offers user's information about the calories burnt during their journey.

The numbers in brackets refer to the references listed herein. The contents of all these references are incorporated herein by reference.

It is recognized that modifications and variations of the invention will be apparent to those of ordinary skill in the art and it is intended that all such modifications and variations be included within the scope of the appended claims.

### REFERENCES

[1] Sthephane de la Rue du Can and L. Price. Sectoral trends in global energy use and greenhouse gas emissions. Energy Policy, 36(4):1386-1403, 2008.
[2] International Energy Agency. International energy agency, open energy technology bulletin. http://www.iea.org/impagr/cip/archived_bulletins/issue_no23.htm, November 2004.
[3] Carbon Diem. http://www.carbondiem.com.
[4] Green Meter. http://hunter.pairsite.com/greenmeter/.
[5] Simjee, F.; Chou, P. H.; “Accurate battery lifetime estimation using high-frequency power profile emulation,” Low Power Electronics and Design, 2005. ISLPED '05. Proceedings of the 2005 International Symposium on, vol., no., pp. 307-310, 8-10 Aug. 2005.
[6] B. W. Parkinson, “GPS error analysis,” Global Positioning System: Theory and Applications, vol. 1, pp. 469-483, 1996.
[7] Lester, J., Hurvitz, P., Chaudhri, R., Hartung, C. and Borriello G. (2008) MobileSense—Sensing Modes of Transportation in Studies of the Built Environment. In proceedings of UrbanSense 2008, November 2008, Raleigh, N.C., USA, pp. 46-50.
[8] MSP Research Initiative. http://seattle.intel-research.net/MSP/.

### [9] Raskovic, D.; Giessel, D.; “Battery-Aware Embedded GPS Receiver Node,” Mobile and Ubiquitous Systems: Networking & Services, 2007. MobiQuitous 2007. Fourth Annual International Conference on, vol., no., pp. 1-6, 6-10 Aug. 2007.

[10] J. Ross, N. Shantharam, and B. Tomlinson. Collaborative filtering and carbon footprint calculation, In Sustainable Systems and Technology (ISSST), 2010 IEEE International Symposium on, pages 1-6. IEEE, 2010.
[11] W. Ballantyne, G. Turetzky, G. Slimak and J. Shewfelt. “Achieving low energy-per-fix in cell phones,” GPS World, July 2006.
[12] J. Gama (2004). Functional trees. Machine Learning, Springer.
[13] McLachlan, G. J. and Do, K. A. and Ambroise, C. (2004) “Analyzing microarray gene expression data”, Wiley
[14] Lustrek, M. and Kaluza, B. (2008) “Fall Detection and Activity Recognition with Machine Learning,” Informatica, vol. 33, pp. 205-212.
[15] Phithakkitnukoon, S. and Horanont, T. and Di Lorenzo, G. and Shibasaki R. and Ratti, C., “Activity-Aware map: Identifying human daily activity pattern using mobile phone data”, Human Behavior Understanding—Lecture Notes in Computer Science, pp. 14 25, Springer, 2010.
[16] Liao, L. and Patterson D. J. and Fox D. and Kautz H., “Learning and inferring transportation routines,” Artificial Intelligence vol. 17, pp. 311-331, 2007.

### [17] Mark Hall, Eibe Frank, Geoffrey Holmes, Bernhard Pfahringer, Peter Reutetnann, Ian H. Witten (2009); The WEKA Data Mining Software: An Update; SIGKDD Explorations, Volume 11, Issue 1.

### [18] Yang, Y. C. and Toida, T. and Hong, C. M. (2010) “Transportations Prediction Using Build-in Triaxial Accelerometer in Cell Phone”, International Conference on Business and Information, BAI 2010.

[19] Bao. L. and Intille, S. S. (2004), “Activity recognition from user-annotated acceleration data”, Pervasive Computing, pp. 1-17, Springer.

[20] Nham, B. and Siangliulue, K. and Yeung, S. “Predicting Mode of Transport from iPhone Accelerometer Data”, Stanford University class project.

What is claimed is:

1. System for automatically estimating in real time a person's carbon dioxide emissions comprising:
a mobile device including an accelerometer, a GPS receiver and a data plan connection for computing distance, the mobile device programmed:
to pre-process signals from the accelerometer to address variable inter-sample intervals;
to apply a supervised machine learning algorithm based on functional trees to features computed by Fast Fourier Transform of total acceleration acting on the mobile device and computed from the pre-processed signals to determine the mode of transportation of the mobile device; and
to compute carbon dioxide emissions from the mode of transportation and distance travelled.

2. The system of claim 1 wherein the mobile device is a smartphone.

3. The system of claim 1 wherein the carbon dioxide emissions are displayed on the mobile device.

4. The system of claim 1 wherein users share the computed carbon dioxide emissions with other persons.

5. The system of claim 1 wherein the mobile device displays other user's total and average CO₂ emissions.

6. The system of claim 1 wherein the mobile device computes calories burned by a user.

7. The system of claim 1 wherein the mode of transportation is selected from the group consisting of bus, subway, walk, bike, train, car, motorcycle, still.

8. The system of claim 1 wherein the data plan connection uses online map readings.

9. System for automatically estimating in real time a person's carbon dioxide emissions comprising:
a mobile device including an accelerometer, a GPS receiver and a data connection plan, the mobile device programmed:
to apply an algorithm to features computed from total acceleration acting on the mobile device to determine the mode of transportation; and
to compute carbon dioxide emissions from the mode of transportation and distance travelled.
